(19) United States
(12) Patent Application Publication
(10) Pub. No.: US 2010/0036745 A1
(43) Pub. Date: Feb. 11, 2010

(54) SYSTEM AND METHOD FOR THE SALE AND DELIVERY OF GIFT CARDS

(75) Inventor: Delisa L. Kasab, Troy, MI (US)

Correspondence Address: GIFFORD, KRASS, SPRINKLE,ANDERSON & CITKOWSKI, P.C, PO BOX 7021, TROY, MI, 48007-7021, US

(73) Assignee: The Taubman Company LLC

(21) Appl. No.: 12/186,956

(22) Filed: Aug. 6, 2008

(51) Int. Cl. G06Q 30/00

(52) U.S. Cl. 705/26

(57) ABSTRACT

A system for selling gift cards to consumers and delivering the gift cards to the consumers includes an Internet accessed website. An order form on the website allows the consumer to enter appropriate identification apparatus, credit card information and desired pickup day or delivery instructions. The purchaser then receives a confirmation number. The identification and credit information is then sent to the seller and used to obtain approval of the credit information on the order from a third party processor. The seller advises the consumer if the credit is not approved. Otherwise the consumer can pick up the gift cards at the seller's facility upon presentation of the confirmation number, identification and credit card. Alternatively, the seller will deliver the gift cards to the consumer.

### FIELD OF THE INVENTION

This invention relates to a system and method for allowing consumers to purchase and receive delivery of gift cards from a seller, which system and method provides minimum processing costs.

### BACKGROUND OF THE INVENTION

“Gift cards” constitute physical cards resembling credit cards, which are sold to consumers and provide the consumers with a prepaid store of monetary value that may be used to pay for purchases at specified redeeming establishments. Some gift cards only allow the use as payment at a specified redeemer, while other gift cards may be used for payment at any merchant in a multi-retailer location, such as a shopping mall, or at any retailer which is part of a specified chain.

Gift cards are usually purchased by consumers to give away as gifts. They avoid the difficulty of choosing a gift which will please the recipient and seem less “commercial” than gifts of cash. From the redeeming merchant's standpoint the gift cards direct consumers to the merchant's location and gift card users often purchase items in excess of the value of the gift cards. Since gift cards provide advantages to the persons giving the cards as gifts, the recipients of the gift cards, and the merchants issuing them, their popularity has blossomed in recent years.

Purchase of the gift cards using the Internet has a number of advantages to both the purchaser and the redeeming merchant issuing the gift cards, but an economic problem arises when the gift cards are sold by a party other than the merchant who will redeem the cards. Tie profit on the sale of a card by a third party is extremely limited, because consumers expect to purchase the cards for essentially face value. Thus if a gift card has a face value of $100, the consumer is generally not prepared to pay a premium of more than a dollar or two over that value to purchase the gift card. When the gift cards are sold by the redeeming merchants, they look to the potential profit upon redemption of the card to offset the sales cost but the small price increment over the face value of the card is generally not enough of a margin to compensate a non-redeeming seller for the cost of maintaining an online website and the processing costs associated with obtaining credit approval for the purchases. Such non-redeeming seller might typically be the manager of a mall desiring to enhance the businesses of its tenant merchants by selling gift cards that can be redeemed by these merchants. Using prior art online sales systems for the gift cards which employ online credit approval by third party card processors, forced these sellers to incur substantial losses on the sales.

### SUMMARY OF THE INVENTION

The present invention is accordingly directed at a system and method for allowing sale of credit cards in an online process, while decreasing the cost of third party credit processing, so that the seller who is not a merchant redeeming the cards, but has other motives for engaging in the transaction, such as to promote business at a mall managed by the seller, can manage losses on the transaction.

In a preferred embodiment of the invention, which will be subsequently disclosed in detail, the sales transaction is essentially divided into two steps. In a first step, a would-be purchaser of a gift card communicates via the Internet to a website maintained by the non-redeeming seller and accesses a form which the purchaser must fill out, on an online basis, in order to initiate the transaction. The form requires the purchaser to enter personal information such as name, address, phone number and the like and credit information such as a credit card number or the like. The form also includes blanks for the purchaser indicating whether the ordered gift cards will be picked up at the retail location of the seller or, alternatively, they should be delivered by the seller to an indicated address of the purchaser. When tie form has been correctly filled out, a transmission is sent via the Internet, providing the purchaser with a confirmation number.

In prior art systems, the credit information is provided from the seller's website to a third party credit processor for approval. This may be done while the purchaser is on line, or after the purchaser fills out the form and leaves the website. The charge by the processor for this service is relatively high since the processor does not see the credit card but assumes liability to the gift card seller, and the true owner of the credit card, in the event that card is misused.

However, in accordance with the present invention, to avoid the relatively high charges the third party credit card processors makes for such online transactions, the information that the purchaser has entered in the form is transmitted to the seller's computer. It is then entered into the retailer's conventional point-of-sale credit card authorization system for transmission to a third party credit card processor. Because of the large number of credit card transactions processed by a seller such as a mall proprietor, and the fact that the gift card seller will review the credit card at the time of delivery of the gift cards to the purchaser, the third party credit authorization charge for each transaction will be much less than the charge made if the credit authorization were performed online, directly from the website, with the assumption of liability by the processor.

The third party transaction processor will communicate to the seller's computer as to whether the charge is approved or rejected. If it is rejected the retail center will communicate with the customer to advise of the rejection. Otherwise, the purchaser may pick up the credit cards on the date indicated on the form at the seller's location used for the purchase by providing the credit card and the confirmation number or, alternatively, if delivery has been requested by the purchaser, the seller will deliver the goods to the purchaser.

### BRIEF DESCRIPTION OF THE DRAWINGS

Other objects, advantages and applications of the present invention will be made apparent by the following detailed description of a preferred embodiment of the invention. The description makes reference to the accompanying drawings in which:

FIG. 1 is a schematic diagram illustrating a preferred embodiment of the system of the present invention;

FIG. 2 is a view of a web based order form for use by the purchaser in order to obtain the gift card; and

FIG. 3 is a block diagram of the steps of the method of the present invention.

### DETAILED DESCRIPTION OF THE PREFERRED EMBODIMENT

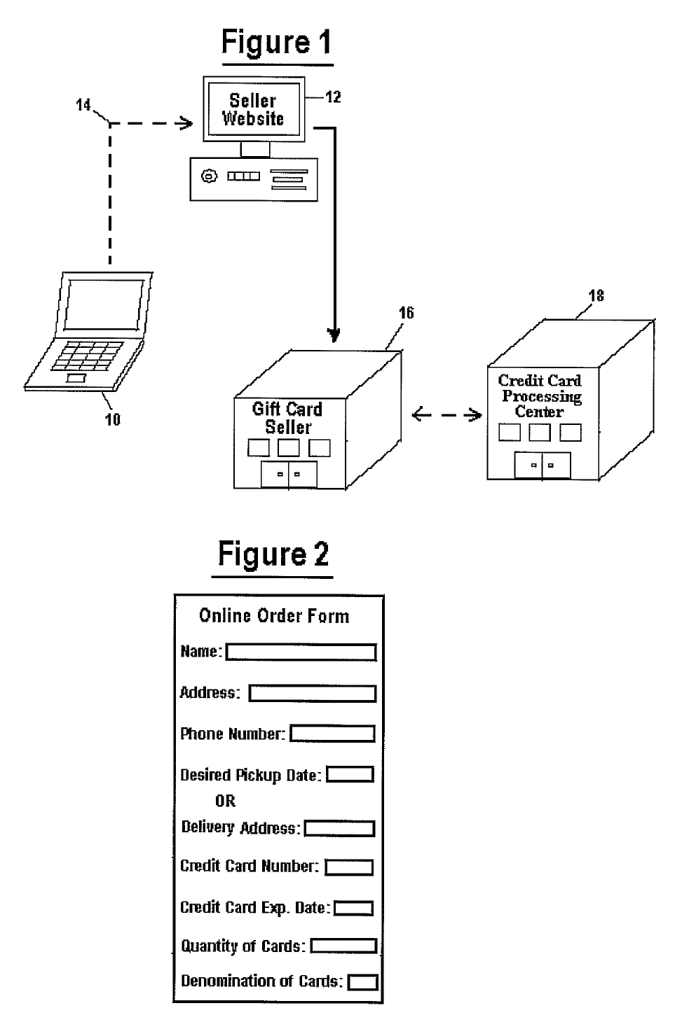

Referring to the drawings, FIG. 1 illustrates schematically the elements used in purchasing gift cards employing the system of the present invention. The process is initiated by a customer employing a personal computer 10 to contact a website 12 maintained on the Internet, through an Internet connection 14. The website 12 will typically be useful for purposes other than purchasing gift cards, and, for example, can contain descriptions of the mall tenants in the event that the seller is a mall proprietor, but will include sections that allow the purchase of gift cards.

With appropriate navigation on the site, the potential purchaser using the personal computer 10 can obtain an online order form of the type generally illustrated in FIG. 2. The form will typically require personal information of the purchaser such as name, address, phone number and the like, either pickup date or delivery address for the cards, credit card information, and the number of cards to be purchased and the denomination. When the form 16 of FIG. 2 is properly filled out, the web server 12 will transmit a confirmation number to the user computer 10.

A communication is then sent from the web server 12 to a computer 16 available to the gift card seller. The communication includes the completed form 2 or the information contained in the form. The gift card seller then transmits the credit information related to the required transaction to a third party credit card processing computer 18. This process may involve the manual entry of the credit card number and the expiration date into the communication, since the credit card itself is not available. Assuming that the card seller is a mall owner or manager, a large number of credit card transactions will be handled through the third party credit card processing center 18 and accordingly the cost of each transaction will be relatively low, substantially less than would be required for a third party processor to process the transaction online from the website 12.

The third party credit card processing center 18 then determines if the transaction is approved or rejected and transmits that information to the computer 16 at the seller's location. If the transaction is rejected, the gift card seller sends a message, either by email or phone, to the purchaser 10 indicating that the credit has not been approved. Otherwise the order of cards is preserved at the seller's location for pickup by the purchaser or if the purchaser has requested shipment, the cards are manually or personally delivered to the address designated by the purchaser.

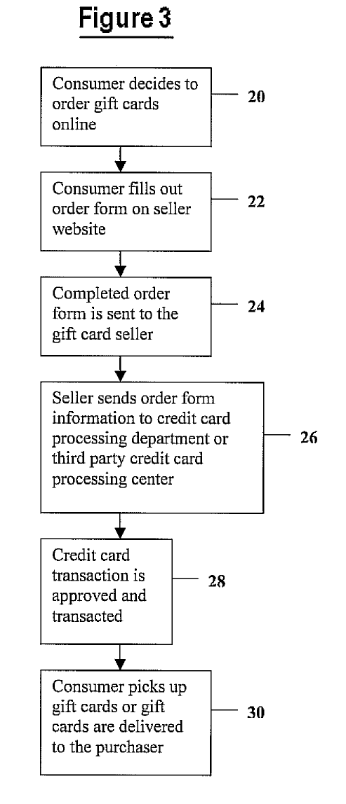

These steps are reflected in the flowchart of FIG. 3. At the initiating box 20 the consumer decides to order gift cards online and contacts the website of the seller. At 22 the consumer fills out the form of the type generally shown in FIG. 2. The web server 12 then transmits the form or the information in the form to the seller's location at box 24. At box 26 the seller sends the order form information to the third party processor 18. Next the third party processor sends a message to the seller's computer indicating that the transaction is approved or rejected, at 28. At 30, assuming credit has been approved, the consumer picks up the card by showing the credit card and the confirmation number, or alternatively the cards are delivered to the purchaser and the credit card used for the transaction is reviewed by the deliverer.

Having thus described my invention I claim:

1. A system for enabling the online purchase of gift cards for use in redeeming establishments by a consumer, from a seller, which does not maintain a redeeming establishment, and the physical transfer of the purchased gift cards to the consumer, comprising:
providing a website on the Internet containing order forms for the purchase of gift cards, such forms requiring entry of purchaser identification, credit identification for the purchase and delivery information;
providing the purchaser a confirmation number for the purchase via the Internet; transmitting the completed form to a computer under the gift card seller's control via the Internet;
entering and transmitting the credit information in the form by the seller to a third party credit processor;
transmitting a credit approval or denial message from the third party processor to the credit card seller; and
delivering the gift card to the purchasing consumer upon the credit card being approved and the purchaser providing the seller with the confirmation number.

2. The system of claim 1 wherein the web based order form may include a request for delivery by the purchaser to an identified location, and upon the seller receiving credit approval from the third party processor, the seller delivers the gift card to the consumer identified delivery location.

3. The system of claim 1 wherein the seller manually enters the consumers credit information into the transmission to the third party processor.

4. The system of claim 1 wherein the seller is the landlord of the redeeming establishments.

5. A method of marketing gift cards for use in redeeming retailers by a seller other than a redeeming retailer, to consumers, comprising:
providing a web based order form for the gift cards, the order form requiring entry of purchaser identification, credit information and delivery information;
malting such web based order forms available to consumers via the Internet;
transmitting the consumer entered information on the web based forms to the gift card seller;
manually entering and transmitting consumer entered information by the seller to a third party credit processor;
transmitting information from the third party credit processor to the gift card seller regarding the status of credit approval; and
upon receiving approval of credit from the third party credit processor, the seller providing the ordered gift cards to the purchaser in the manner indicated on the order form.

6. The method of claim 4 in which the seller is the landlord of the redeeming retailers.
